(19) United States
(12) Patent Application Publication
(10) Pub. No.: US 2004/0103630 A1
(43) Pub. Date: Jun. 3, 2004

(54) Pneumatic harvester

(76) Inventor: Michael S. Kitchen, Charleston, SC (US)

Correspondence Address: B. Craig Killough, Barnwell Whaley Patterson & Helms, LLC, P.O. Drawer H, Charleston, SC, 29402-0197, US

(21) Appl. No.: 10/721,914

(22) Filed: Nov. 25, 2003

Related U.S. Application Data
(60) Provisional application No. 60/429,239, filed on Nov. 25, 2002.
(60) Provisional application No. 60/439,363, filed on Jan. 10, 2003.

(51) Int. Cl. A01D 46/00

(52) U.S. Cl. 56/13.1

(57) ABSTRACT

A device and method of harvesting a crop using positive and negative air pressure that is produced with in a partially closed area. Air flow that is produced by the positive and negative air pressure severs the crop from the remainder of the plant. A vacuum is introduced into one or more collection chambers. Air is introduced into the collection chamber by the application of positive air pressure. The negative pressure, or vacuum, is applied to the collection chamber through vacuum conduits or tubes that communicate with one or more collection ports. A crop, such as a cotton boll, is exposed to the collection port, and is pulled from a plant and harvested by vacuum, and is transported by the vacuum conduits or tubes to a hopper or other collection area. The geometry of the collection chamber facilitates harvesting of the crop.

This application claims priority on provisional application Serial No. 60/429,239 filed Nov. 25, 2002, and on provisional application Serial No. 60/439,363 filed Jan. 10, 2003.

### FIELD OF THE INVENTION

This invention relates to devices and methods for picking crops, such as cotton.

### BACKGROUND OF THE INVENTION

Cotton is currently harvested by what may be characterized as a spindle picking device. Spindle picking devices require an incredibly large number of moving parts. Minimally, each spindle requires the drum with geared drive system, the drive gears for each vertical bar unit, an internal pressure lubrication system, two individual bevel gears for each spindle, doffer system for each horizontal row of spindles, and moistening plate for each horizontal row of spindles. All of these systems and their numerous constituent parts are inter-dependent; malfunction of any one can effect the performance of the entire machine. Current designs utilize in excess of 400 spindles for each head plus multiple support systems.

Current spindle systems have multiple moving parts which are inter-dependent to maintain function of each spindle. A bar with multiple bevel gears forms the drive for each vertical row of spindles (A John Deere design provides for 18 spindles arranged in each vertical row). Failure of this drive system results in dysfunction of all 18 spindles. Likewise failure of the pressure lubrication system can ultimately result in excessive wear and failure of the entire spindle system. The complex inter-relationship of the multiple systems utilized in spindle systems is in itself a testament to the high quality and consistent production standards of modern agricultural manufacturers; that this system does not fail more routinely is amazing. Of note, is the realization on the part of those personnel involved with maintenance of these devices that optimization of performance is highly dependent upon proper function of multiple systems. Variation in adjustment of doffer clearance, moistener flow rates, lubrication schedules, and routine maintenance can adversely affect performance of the machine and lead to excessive wear and early replacement of systems.

Current spindle methods rely upon a rapidly spinning spindle with teeth that twists the fiber as it encounters a lock of cotton. It is this twisting of fiber that provides adhesion to the spindle as it is transported around the drum and to the doffers. During this portion of the harvesting process debris including portions of the burr or stems can become entrained with the cotton fibers.

The spindle picking method is one of positive mechanical engagement. It utilizes a direct drive system that is unforgiving and essentially works by brute force. One of the more common repairs required on spindle machines is the replacement of single spindles broken as a rock of tree limb is encountered, the spindles themselves are made of case hardened steel. There are warnings at the front of each head warning that placement of a limb within the working mechanism can cause severe injury including amputation.

Current methods of construction rely upon heavy weight materials to achieve high power transmission, long service life and durability. This has resulted in a very heavy machine; some current models weigh in excess of 43000 lbs for a six row picker. Of note modern methods of construction have where possible utilized light weight materials in recognition of the need to reduce overall weight where possible.

Current spindle picking devices seem to tend towards complete overhaul of heads based upon hours of use. Incidental repairs occur as single or linked systems fail due to over stress factors or abrasion at contact surfaces. Newer designs have made replacement of a single spindle a fairly simple in field task; however replacement of drive components is usually a complex and expensive proposition.

Current devices are limited to minimal variation in crop size. There are two available height variations available on John Deere models. There is provision for pressure plate variation on current machines which can accommodate some variation in crop size and density. Cotton may grow to 60 inches in height, and the cotton must be bent over by hand to enter the harvesting head.

Current machines use a cage over the picker chassis which when full is dumped into a loose transport trailer or placed in a module builder for compaction. The use of module builders typically requires the picker to go to the edge of the field to dump with resulting loss of picking time. The use of loose material trailers saves trips for the picker to the edge of the field however the cotton is not put into a compacted form and transport volumes to the gin are large compared to the weight transported. It is of note that John Deere has in place a patent application for the installation of an accumulator instead of a loose cage on the picker.

Heretofore, multiple attempts have been made at harvesting cotton using air pressure as the motive force for picking. There exists a historical record of these attempts. Thus far all have utilized vacuum devices of one sort or another. The simplest of these devices were essentially large vacuum cleaners mounted on a trailer or tractor. Workers carried multiple flexible collection tubes about the field and essentially vacuumed the seed cotton off of the plants. Of necessity, this was not a great saving in the human labor required for harvest and was probably not much faster than hand picking.

Owen, U.S. Pat. No. 3,387,437, is directed to a machine that utilizes rotating drums similar in orientation to current spindle picking methods. The centers of the drums are maintained under negative pressure. The cotton is approximated to the surface of the drums by means of mechanical arms and as the bolls are held in proximity to the drum they encounter a series of horizontal slots cut into the drum's surface and thus are exposed to a vacuum and collection is to occur. This system consisted of cylindrical hollow drums with negative interior pressure. Extending from the surface of the drums are mechanical arms that approximate the bolls of cotton to the surface allowing collection of cotton lint through slots cut horizontally into the sides of the drum. The drums spin on their axis and in so doing, the picking surface is presented to the plants at speeds synchronized to ground speed.

Owen does not disclose the use of positive air pressure. There are several readily apparent advantages to the introduction of positive pressure into a collecting device and process. The first and ultimately key advantage to this system is that air under pressure simply equates to more force in the same amount of time. Previous methods have clearly demonstrated that vacuum pressure alone is sufficient to separate the seed cotton from the burr and can be readily obtained using mechanical devices that are commonly available. An ordinary “Shop Vac” will remove the seed cotton from a cotton boll.

### SUMMARY OF THE INVENTION

The invention utilizes one or more collection chambers into which a vacuum is introduced. Air is introduced into the collection chamber by the application of positive air pressure. Negative pressure, or vacuum, is applied to the collection chamber through vacuum conduits or tubes that communicate with one or more collection ports. A crop, such as a cotton boll, is exposed to the collection port, and is pulled from a plant and harvested by vacuum, and is transported by the vacuum conduits or tubes to a hopper or other collection area. The geometry of the collection chamber facilitates harvesting of the crop.

### DESCRIPTION OF THE DRAWINGS

FIG. 1 is a side elevation of the pneumatic harvester of the invention.

FIG. 2 is a perspective view of the collection chamber of the invention.

FIG. 3 is an exploded view of the collection chamber.

FIG. 4A is a side elevation of a module of the collection chamber.

FIG. 4B is a perspective view of a module of the collection chamber.

FIG. 5 is a top plan view of the pneumatic harvester.

FIG. 6 is a side elevation of one half of a collection chamber.

### DESCRIPTION OF THE PREFERRED EMBODIMENTS

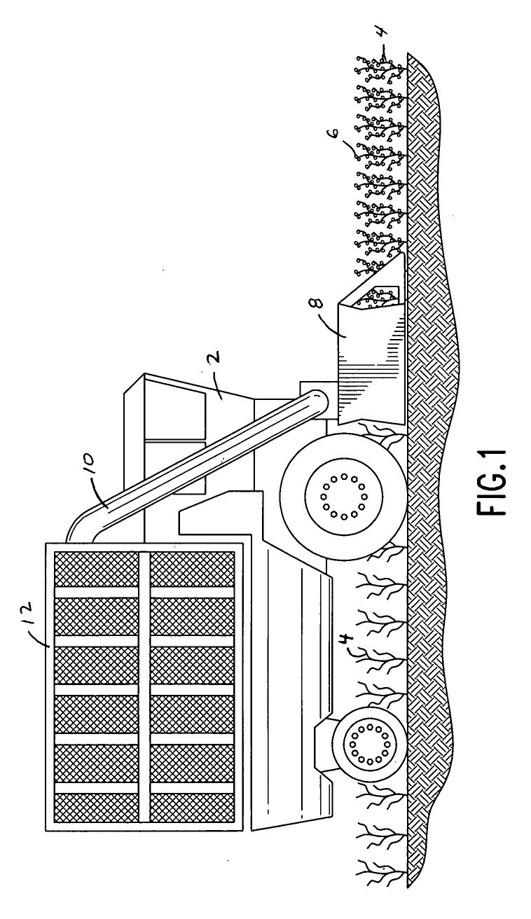

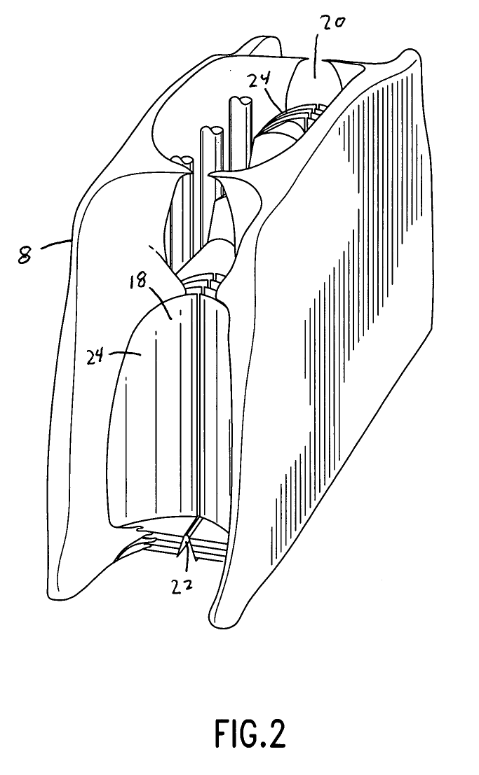

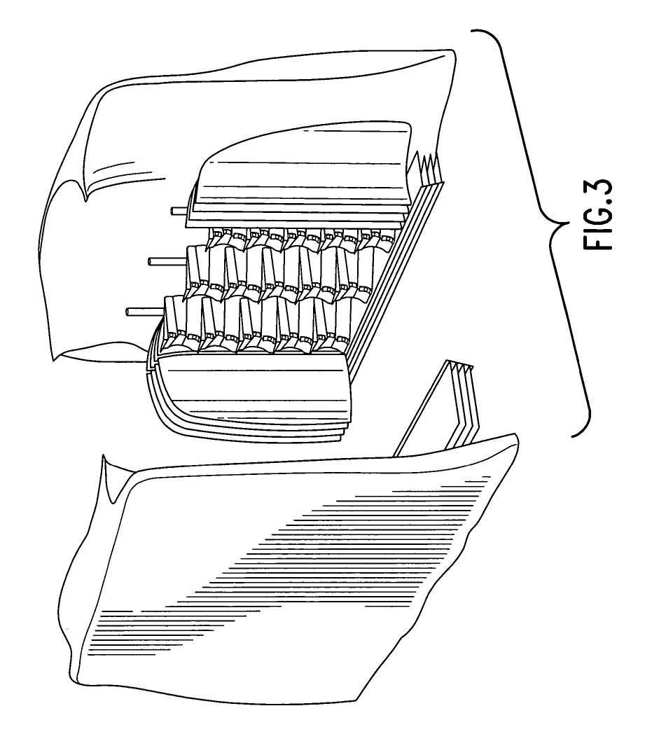

FIG. 1 shows a side elevation of a pneumatic harvester 2 according to the present invention. The pneumatic harvester is shown harvesting cotton, which is the best mode for using the device. Cotton 4 that is ready for harvest with cotton bolls 6 thereon enters the collection chamber 8 mounted to the front of the pneumatic harvester. The individual cotton plants, which are planted in rows, enter the front of the collection chamber, and exit the rear of the collection chamber. The pneumatic forces within the collection remove the cotton bolls from the cotton. In a preferred embodiment, the plants are not cut, and are disrupted only to remove the cotton bolls from the cotton plant.

The pneumatic harvester may be provided with an engine, as with self-propelled harvesters of the prior art, so that the harvester traverses the rows of the field in which the plant is planted, so that material, such as cotton bolls, can be removed from the plant. After the cotton bolls are removed from the plant, they are transported by pneumatic forces through an appropriate conduit 10, and into a hopper 12.

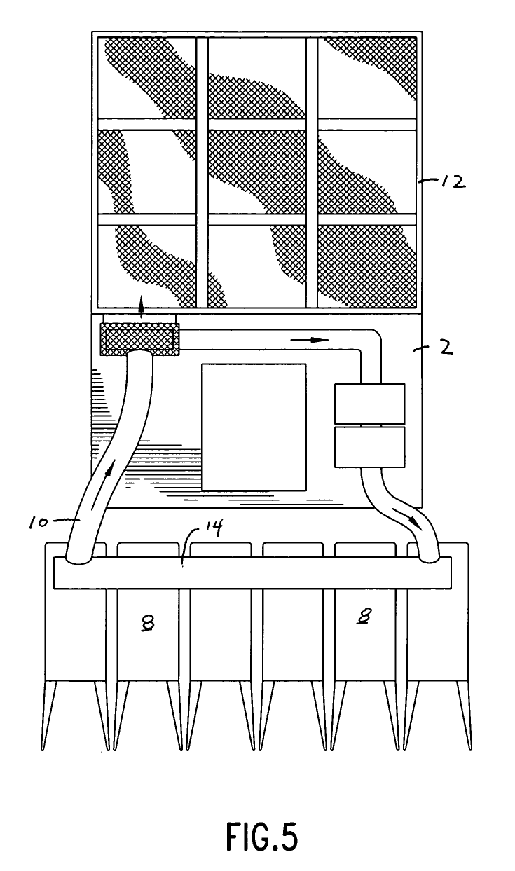

As shown in FIG. 5, multiple collection chambers 8 may be placed side by side. The collection chambers are appropriately spaced apart so as to engage rows of the crop, such as cotton, to be harvested. The collection chambers may be arranged and mounted to the harvester 2 so that the collection chambers are spaced apart as desired, such as by providing a header which permits sliding of the collection chambers relative to each other, and then fixing the collection chambers in position. The vacuum device of the present invention allows the cotton or other plant material that is harvested to be transported into the hopper by vacuum. The header may provide a manifold 14 which communicates with a vacuum source to draw the cotton into the hopper, and the manifold may be accessed by the collection chambers as they are variably spaced.

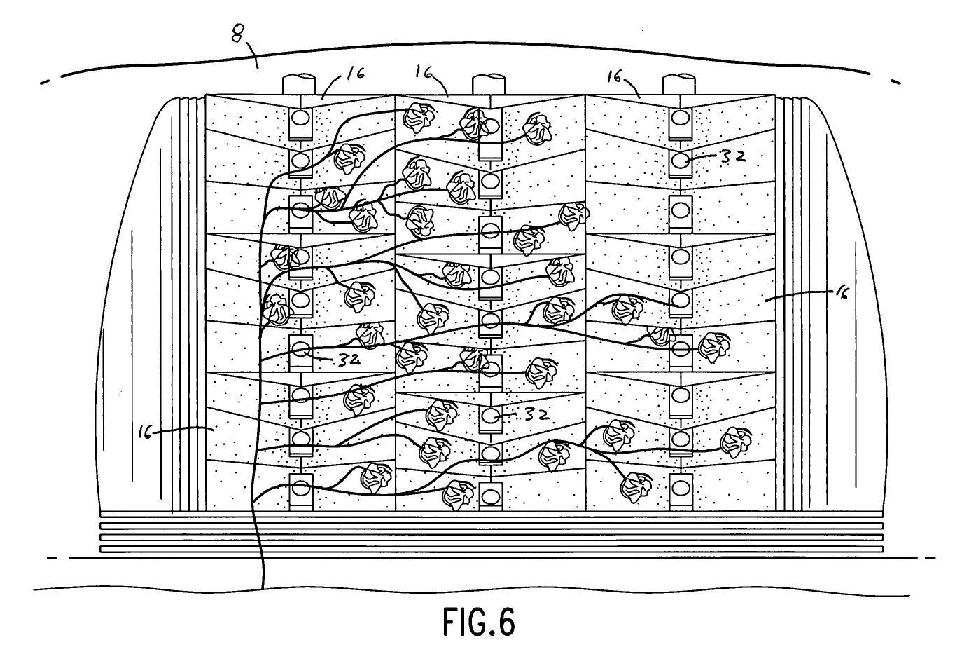

In the preferred embodiment, the collection chambers comprise multiple modules 16. The modules are positioned in an array. As shown in FIG. 6, a three row by three column array of modules is employed, so that there are nine modules on each side of the collection chamber. The number of modules to be used will depend upon the size of the modules, and the crop to be harvested. A single module with appropriate size could be used; alternatively, for example, if cotton is to be harvested, the number of modules will depend upon the height of the cotton and the size of the modules.

The collection chamber has a front opening 18 and a rear opening 20, and in the preferred embodiment, a bottom opening 22. Cotton enters the front opening, passes through a central portion of the collection chamber where the cotton bolls are exposed to positive air pressure and negative (vacuum), and the cotton exits the rear of the collection chamber after the cotton bolls have been removed from the cotton plant. The bottom opening between the two sides of the collection chamber permits the stalks of the cotton plant to pass through the collection chamber, with minimum disturbance to the stalk. The front opening and the rear opening comprise what is called herein a “pseudo seal.” The pseudo seal 24 provides an opening through which the plant to be harvested can pass for entrance into the collection chamber, but minimizes the air flow from the collection chamber to the outside of the device. The pseudo seal is a flexible member having a gap or opening, with the flexibility permitting the plant to enter the collection chamber, while minimizing air flow from collection chamber to the outside. The rear of the collection chamber has a similar structure and is provided for the essentially the same purpose, allowing the plant to exit the collection chamber, while minimizing air flow from the chamber to the outside. The bottom opening has a gap or opening, and a pseudo seal is also provided. The opening to the lower or bottom pseudo seal 26 is generally horizontal, as opposed to the generally vertical openings in the front and rear pseudo seals. In this embodiment, the bottom pseudo seal traverses from the front pseudo seal to the rear pseudo seal, and is positioned substantially against the front pseudo seal and real pseudo seal as shown so as to minimize air transfer between the atmosphere and the collection chamber.

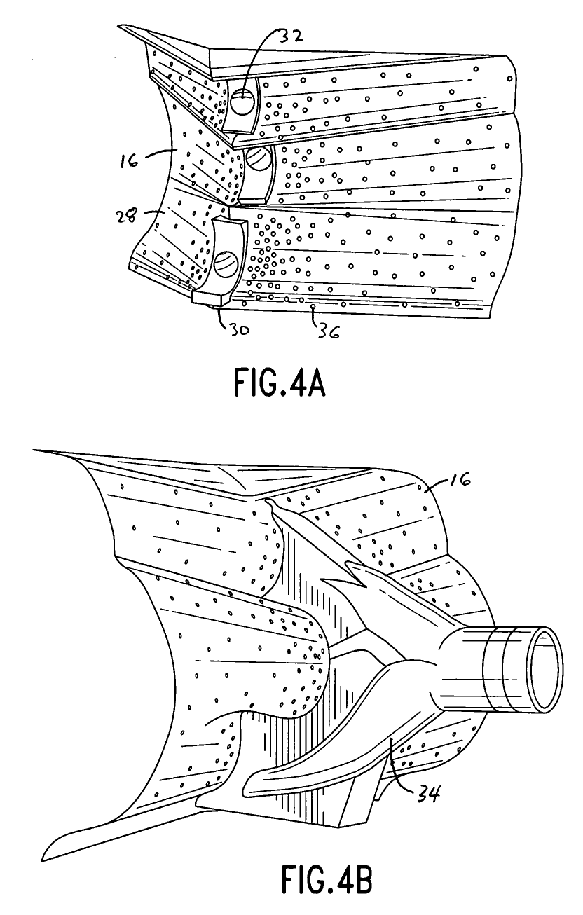

The modules 16 that are positioned within the collection chamber are emphasized in FIG. 4A and FIG. 4B. The modules as shown in this embodiment have an enlarged frontal portion 28 which tapers to a neck 30. Multiple collection ports 32 are positioned in the neck and to the rear of the larger opening. As shown in the drawing figures, there are three collection ports located at, or slightly to the rear of the neck of the device. Moving rearwardly from the neck, the module has an erratic geometry, at least some of which may be sectioned frusto conical shapes. The modules should not have large areas of flat sides. The erratic geometry variously directs the plant after it enters the collection chamber, and the plant is moved about as it travels within the collection chamber, exposing the cotton bolls to the multiple collection ports. A manifold 34 connects the collection ports. The manifold is connected to a conduit, which is in turn connected to the header 14 and then into the conduit 10 that feeds the hopper. A vacuum is present from the collection port and through the conduit that feeds the hopper, and at all intervening points, for transportation of the cotton through the harvester.

As shown in FIG. 4A and FIG. 4B, the modules have a plurality of small orifices 36. Vacuum is also present at the small orifices. The orifices, or perforations, are too small to receive the crop or other material that is being harvested from the plant within the orifice. Accordingly, these orifices are smaller than the collection ports. The small orifices provide a vacuum that pulls the plant being harvested against the sides of the module, so that the crop is exposed to the collection port. The collection port provides substantially more vacuum, due to its larger size. The collection port provides an orifice of sufficient size to collect the crop, whereas the other orifices 36 are too small to receive the crop.

In use, the harvester traverses rows of a field, as shown in FIG. 1. The individual plant enters the collection chamber, and the crop to be harvested is within the central portion of the collection chamber, between the front opening and the rear opening, and above the pseudo seal of the bottom opening. The larger receiving area of the module, due to its tapered structure, funnels the crop toward the neck of the module, where it is exposed to the collection port. The smaller orifices pull the crop against the sides of the module, and the collection ports pull the crop, such as cotton bolls, from the cotton plant as the cotton bolls pass through the restrictive neck area of the module. The small orifices continue to pull the crop toward the side of the module, at which point the plant encounters the next module, and the process is repeated. The use of multiple modules, having multiple restrictive necks in which connection ports are located, and the erratic internal geometry of the modules that constantly move and manipulate the position of the plant, yield a substantial likelihood of effectively collecting the crop from the plant.

In addition to a vacuum, the device also provides positive air pressure. Positive air pressure is forced into the collection chamber, which increases the air flow within the collection chamber to enhance the efficacy of harvesting. In a preferred embodiment, sufficient positive air pressure is provided to the collection chamber so that the air pressure within the collection chamber is somewhat higher that atmospheric pressure. The use of air pressure that is higher than atmospheric air pressure tends to force dirt and debris out of the collection chamber that would enter the collection chamber if only a vacuum were applied to the collection chamber, helping to keep the crop clean. Further, the introduction of positive air pressure provides for additional “turbulence”, further improving the efficacy of the crop collection. However, the device will work with sufficient air pressure being provided to maintain pressure within the collection chamber that is substantially the same as atmospheric pressure, or even negative air pressure, that is, air pressure is below atmospheric air pressure.

Another geometry utilizes a “Y” shaped collection chamber with a high pressure air inlet through center and collector units arranged at sides. The cotton plant passes through the center of chamber and is ideally split into two approximately equal segments by a vertically extending keel.

The invention does not employ cylindrical hollow drums with negative interior pressure, or require mechanical arms that approximate the bolls of cotton to the surface to allowing collection of cotton lint into the drum. Earlier attempts at vacuum harvesting of cotton consisted largely of large vacuum cleaner type devices with multiple suction tubes that were manually approximated to the cotton bolls effecting collection. This design is significantly different from these earlier concepts. There is no active mechanical component in this embodiment of the device. Air pressure applied at the collection interface orientates and approximates the boll for collection. This invention utilizes both a negative pressure or vacuum across the collection plate and positive pressure within the chamber.

Utilization of both positive and negative pressures allows opportunities to control force as applied at the collection point. Positive pressure inlet allows for control of air density within the collection chamber and thus volume of air flow across the collection point for a given negative pressure. Introduction of positive pressure enhances speed of separation and efficiency of collection. Further, having the positive side and negative side of the vacuum system under control helps in optimizing the functions of separation, approximation and collection. By adjusting the relative and total contributions of positive and negative vacuums a curve may be derived wherein maximal approximation is balanced against that required for optimal collection. There exists the possibility of fluctuating the pressures within this system that may enhance separation of bolls from entanglement in vegetation and approximation to the collection surface.

Additionally, the chamber design anticipates the use of a “low vacuum” component wherein continuous low vacuum is applied through the surface of the collection array, facilitating approximation of the bolls to the collection surface. This low vacuum stream may be utilized in transport of the cotton to the packaging components of the picker. The simplest configuration provides high vacuum sides having both the force for picking and sufficient motive force for transport.

A “T” shaped chamber that effectively separates the top portion of the plant into three segments is another collection chamber embodiment. Additionally, an “I” shaped chamber with collection at both vertical surfaces could be used. Certain varieties of cotton may lend themselves to more efficient picking with the various geometries as suggested, or certain regions, and particularly high yield regions, may require different geometries.

Passive systems for boll approximation would include surface variation at the collection surface including the provision of “voids” to allow boll to dwell in front of the collection orifice. Included in the design for the collection surface are “lips” incorporated within the surface treatment that cause hesitation in forward progress of the boll, subsequent release and following reversal of direction of travel causing a temporal pause or dwell of the boll lengthening potential collection time. A portion of the array design may be devoted towards achieving exclusion of plant material from the collection surface. A system of horizontal bars of horizontal ridges excludes those elements of plant material that are linear in form, and specifically, the branches of the plant.

Dimensions of the collection chamber are variable to accommodate differences between varieties of cotton and yearly variation of crops. Standards may be derived wherein specific adjustments may be “dialed in” to suit the immediate crop conditions. These variables may be controlled automatically through monitoring collection efficiency. The geometry of the “Y” configuration lends itself to adjustment of chamber depth simply by moving the keel structure vertically.

Treatment of the collection surfaces provides means to facilitate boll approximation. Textured surfaces may enhance drag and adhesion quality. Certain portions would require minimal adhesive qualities and might best benefit from non-stick surfaces or surface treatments. In another embodiment, the use of static charge increases attraction of the boll towards the plate.

### SUMMARY EMBODIMENTS OF THE INVENTION

1. Positive and negative air pressure to separate a crop (seed cotton) from the plant (cotton plant).

2. Variable aperture collection orifice/channel wherein separation of the crop (seed cotton) from its parent plant (cotton plant) occurs.

3. Time specific activation of the variable collection orifice/channel to optimize collection and conserve energy.

4. Variable patterns of activation that change dependent upon harvesting conditions.

5. Optical or electrostatic detection of proximity of the crop (seed cotton) to the collection orifice/channel.

6. Variable timing of activation of the aperture when detection occurs.

7. A collection surface designed to maximize approximation of the crop (seed cotton) to the collection orifice/channel.

8. A collection surface designed to maximize orientation of the crop (seed cotton) to the collection orifice/channel.

9. Introduction of a positive pressure air stream through which the plant (cotton plant) passes in the collection process.

10. Introduction of negative pressure through which the plant (cotton plant) passes in the collection process.

11. Variable geometry of the passageway through which the plant (cotton plant) passes in the collection process.

12. Devices for facilitating orientation/approximation of the crop (seed cotton) within the passageway through which the plant (cotton plant) passes in the collection process.

13. Provision for geometric variability to cross section as the plant (cotton plant) passes linearly through the collection passageway.

14. Provision for “reorientation” of the plant (cotton plant) as it passes through the collection passageway. (transitional geometry through variable cross sections)

15. Variable scale adjustment of the passageway through which the plant (cotton plant) will pass in the collection process.

16. Modular structure allowing variability to the number of collection orifices/channels employed in a given configuration.

17. Modular structure allowing variable size and geometry of the passageway through which the plant (cotton plant) passes in the collection process.

18. Provision for a front seal maintaining negative/positive air pressure environment within the passageway through which the plant (cotton plant) passes in the collection process.

19. Provision for a rear seal maintaining negative/positive air pressure environment within the passageway through which the plant (cotton plant) passes in the collection process.

20. Provision for a bottom seal maintaining negative/positive air pressure environment within the passageway through which the plant (cotton plant) passes in the collection process.

21. Provision for a bottom seal excluding debris from the negative/positive air pressure environment within the passageway through which the plant (cotton plant) passes in the collection process.

22. A positive pressure conduit supplying positive pressure air to the passageway through which the plant (cotton plant) passes in the collection process.

23. A negative pressure conduit or plurality of conduits through which the crop passes for central processing/packaging.

24. A negative pressure conduit that produces a vacuum at the collection orifice/channel thus supplying motive force for collection of the crop (seed cotton).

25. A negative pressure conduit that produces a vacuum at the collection surface thus orientating/approximating the crop (seed cotton) to the collection surface.

26. A negative pressure chamber within which the crop (seed cotton) is separated from the air stream.

27. Incorporation of a condenser device within the negative pressure chamber.

28. Incorporation of a secondary condenser or filter to extract debris from the air stream.

29. Extraction of the separated crop (seed cotton) from the negative pressure chamber through an air seal.

30. Extraction of the separated crop (seed cotton) and processing it in such a manner that it forms a mat for further processing (round baler).

31. Extraction of the separated debris from the negative pressure chamber through an air seal.

32. Expulsion of separated debris to the ground.

33. Provision of a compressor (series variable pitch/speed fans) to provide vacuum for the negative pressure collection/condensation process.

34. Control of negative pressure within the negative pressure chamber.

35. Provision of a compressor in series with the negative pressure compressor to provide positive pressure air to the positive air pressure conduit for introduction into the collection passageway through which the plant (cotton plant) will pass in the collection process.

36. Provision of a compressor in series with the negative pressure compressor to provide positive pressure air to the positive air pressure conduit for use in blowing debris from the plant (cotton plant) prior to entrance to the collection passageway.

37. Interposition of vents to allow egress of air between the series compressors.

38. Interposition of vents to allow ingress of air between the series compressors

39. Utilization of information derived from collection frequency in determining crop yield.

40. Crop drying at a conveyor to baling device that utilizes air flow from a radiator fed through alternate muffler heat exchanger to dry crop as it passes in mat form on conveyer to baler.

41. Provision for reversal of air flow for purge cleaning of high vacuum air ducts.

42. Provision for testing sequences to monitor function of individual collection orifices and their mechanisms by means of system pressurization and monitoring of pressure fluctuations as individual collection orifices are made to cycle.

43. Provision for each row head unit to rotate upward on a frame and thus provide service access to the sides of adjacent row head units. Side access to heads for pressure washer cleaning of low vacuum chambers.

44. Row sensing occurs at individual row heads allowing three dimensional freedom of motion about a single point of fixation for each head.

45. For active front seal systems provision is made for synchronization of front seal to ground speed.

46. For active rear seal systems provision is made for synchronization of rear seal to ground speed.

47. A burr excluder at collection orifice/channel.

48. Side access to heads for pressure washer cleaning of low vacuum chambers.

49. A passive seal system for both front and back applications.

Additional Embodiment 1

The Process of Using Positive and Negative Air Pressure to Separate a Crop (Seed Cotton) from the Plant (Cotton Plant).

Collection occurs at an interface between a contained volume at relatively high pressure and a vacuum at relatively low pressure. This interface wherein separation of the cotton from the burr actually occurs is an orifice or channel that connects with an enclosed volume at vacuum. The principle of physics that is exploited here is that air at higher pressures has greater mass per unit volume. This principle allows for greater force to be applied to an obstructing object as it encounters the orifice or channel. A force of less than 3 lbs applied to locks of cotton contained within a boll is sufficient to separate said locks of cotton from the burr. The burr itself is rather firmly attached to the plant and can withstand forces of greater than 10 lbs prior to separation from the plant.

1. The collection surface is shown as an attenuated small plate it would in fact be the entire internal lining of the collecting passageway or chamber and might in fact be of highly complex geometry.

2. The High positive pressure area is shown open it in fact lies with in the collecting passageway or chamber and is in fact “contained”.

3. Two helical tube valves are shown; in all probability only one valve would be required, if even that (a fixed orifice might perform quite well).

Additional Embodiment 2

A Variable Aperture Collection Orifice/Channel wherein Separation of the Crop (Seed Cotton) from its Parent Plant (Cotton Plant) Occurs.

Variable aperture collection unit allows control of force applied to cotton for the collection process. Providing for variability of the aperture size allows for application of force in the collection process to be varied and maximize efficiency of collection. As the locks of cotton are collected they produce the effect of reducing the cross sectional area of the collection orifice, this produces a greater velocity effect of the air which is traversing the orifice. This increased velocity impacts the speed at which the cotton separates from the boll and the amount of force that is acting upon the seed cotton. The present design effects variability in aperture size utilizing a “helical tube valve device”. This is a flexible segment of tubing that when twisted on its longitudinal axis changes the cross sectional area of the aperture. This is not the only valve mechanism that might function in this capacity, however was chosen due to its rapid speed of operation and relative simplicity. Additionally, coupling this device to a servo mechanism allows for variability of opening size and variability speed and duration. For a device of this type to operate at a ground speed of 6 mph and have approximately 200 collection units operating at 33% positive collection per operative event, each unit must be capable of cycling at not less than twenty cycles per second.

Additional Embodiment 3

Time Specific Activation of the Variable Collection Orifice/Channel to Optimize Collection Efficiency and Efficacy, and to Conserve Energy.

The activation of the collection orifice/channel should be intermittent in nature. Intermittent activation will result in conservation of energy and lowered overall power requirements. Several methods of activation have been proposed including a regular repeating pattern, direct activation in response to detection of cotton or possibly a combination of the two.

Multiple readily foreseeable variables will be involved in the formulation of optimal timing of a device of this sort. The nature of an annularly activated helical tube lends itself well to variable voltage control utilizing a servo motor. Empiric experimentation will yield aperture size and timing curves or tables that can form a basis for collection algorithms. As a collection cycle starts and progresses, inherent efficiency is derived by having the collection orifice variable in size over time. In some applications, the aperture should instantaneously open to maximal diameter to accelerate the column of air immediately in front of it as fast as possible. This air will of necessity have some inertial effect and require some time to get moving and apply force to the cotton approximate to the collection orifice. There will additionally be a time lag between detection of the cotton and activation of the device. The actual length of time from detection to activation of the servo should be very short; however there will also be inertial effects secondary to the mass of the valve and servo and the previously mentioned inertia of the air. This time variable will also need to respond to the relative ground speed of the machine as the cotton passes across the collection surface between detection device and collection orifice/channel.

Aperture opening curves that optimize probability of collection occurring, completeness of collection, speed of collection, and energy efficiency may be developed from empirically observation. In an inertial system lessening the diameter should have an immediate but transitory effect of increasing velocity and force. The least complicated arrangement of the collection units will be for them to share a common vacuum source. This arrangement will equilibrate very quickly, and the acceleration effect at any given orifice will be very brief in duration. As the machine faces a greater load of collection, there will occur an increased vacuum in the overall system, as more cotton will be partially obstructing more collection orifices/channels simultaneously.

Additional Embodiment 4

A Variable Pattern of Activation which Changes as a Function of Harvesting Conditions.

Furthering the principles elaborated in Embodiment 3, there exists the possibility of having the machine respond to changing harvest conditions by varying timing and collection orifice/channel size. Harvest conditions vary greatly; characteristics of crop change with geography, seasonal variations, immediate weather conditions, and plant varieties. The ready availability of micro adjustments to timing and aperture opening curves through microchip memory algorithms or continuous monitoring of performance should be eventually integrated into this system. Major adjustments to these variables may even allow the adaptation of this machine to crop conditions that heretofore were un-harvestable. As an example, current devices will not allow harvesting in very wet conditions. However, a wet/dry “Shop Vac” is capable of picking up a wet rag. Modern gins frequently incorporate drying towers as part of their processing of cotton.

Additional Embodiment 5

An Optical or Electrostatic Means for Detection of Proximity of the Crop (Seed Cotton) to the Collection Orifice/Channel.

An optical detector placed proximal to the collection orifice/channel relative to the path of crop (seed cotton) as it transverses the passageway. This allows selective activation of the collection orifice/channel. The optical device is sensitive to specific frequency of light; and as an object having selected color characteristics came into view the optical detector would send a signal activating the collection orifice/channel through the specified collection events previously described for time sequencing. An alternate method of collection might be through the use of electrostatic detection devices. This is the preferred embodiment if electrostatic charges are part of the system, such as a utilizing a charge for approximation of the crop to collection surfaces. The specific distance between detection device and the collection orifice/channel is compensated for with time delay, while also accounting for ground speed of the harvester.

Additional Embodiment 6

Variable Timing of Activation of the Aperture when Detection Occurs.

Variable timing factors play a role in adjusting the machine through development and are of concern as well in the adaptation of the machine to speed changes and variable crop conditions. The proper timing of activation between the detection of crop and opening of the collection orifice/channel is of particular import in function of the machine as well as in conserving energy. Variable timing facilitates collection occurring in differing crop conditions including, but not limited to, moisture content, stage of ripeness, and size/density of individual bolls on the plants. Additionally there are probably differences between varieties of cotton that may require changes in timing as well.

Additional Embodiment 7

A Collection Surface Designed to Maximize Approximation of the Crop (Seed Cotton) to the Collection Orifice/Channel.

At least two orders of geometric design for the optimization of collection surface geometry will exist. Specific treatment directed towards approximation is addressed here. A relatively macro scale geometry may be utilized to create areas that attract bolls as they travel through the collection passageway. Raised parallel structures orientated along the path of travel can serve to exclude plant material consisting primarily of stems in a defoliated crop from close approximation to the collection surface. Further, voids in proximity to the collection orifice/channel can help to gravitate full bolls to these points. Additionally micro scale geometry of surface finish may be provided that creates a drag effect holding bolls against the surface as they pass along. It should be noted that these treatments are to operate in conduction with active low vacuum approximation with perforations at collection surface.

Additional Embodiment 8

A Collection Surface that Maximizes Orientation of the Crop (Seed Cotton) to the Collection Orifice/Channel.

Consideration for surface treatment within the collection passageway is given to maximize orientation of the crop (seed cotton) towards the collection orifice/channel. Just as approximation of the crop facilitates collection occurrences, so does proper orientation of the individual bolls towards the collection orifice/channel enhance the probably of collection. Provision is made for treatment of the collection surface to enhance orientation towards the collection orifice/channel. This is accomplished with the adhesive characteristics of finish that produces drag upon the cotton fiber as well as use of stem exclusion ridges that tend to place the point of burr attachment away from the collection surface and orifices/channels. A void immediately in front of the orifice/channel that allows the boll to turn outward provides additional orientation enhancement.

Additional Embodiment 9

A Passageway having Provision for Introduction of a Positive Pressure Air Stream through which the Plant (Cotton Plant) will Pass in the Collection Process.

The collection passageway forms a chamber through which the plant passes and the harvesting of the crop (seed cotton) occurs. Fundamental to the invention is the provision for the introduction of positive pressure air into the collection interface. Introduction of positive pressure air into the passage way occur through a variety of configurations. One embodiment provides a central “keel” which serves to physically divide the plants and allows ducting space for positive pressure air supply. A simple linear path of air from center of the collection chamber is provided across the plant, and through the negative pressure slots in the collection surface and high vacuum collection orifices/channels. This linear relationship, however, is not necessary for the proper function of the harvester. Positive pressure air supply may vent into the collection passageway with any geometry. It is the provision for greater mass of air passing through the system for a given unit of time that is fundamental to greater applied force in the collection process and not the directional characteristics of air supply that determines force applied. Directional flow characteristics might aid in approximation and orientation of the bolls and should be considered in design choices; however, these considerations should not dictate the geometry of the collection passageway.

Additional Embodiment 10

A Passageway having Provision for Introduction of Negative Pressure through which the Plant (Cotton Plant) will Pass in the Collection Process.

The collection passageway forms a chamber through which the plant passes and the harvesting of the crop (seed cotton) occurs. Fundamental to the invention is the provision for the introduction of negative pressure which removes the crop (seed cotton) at the collection interface and serves to approximate the bolls to the collection surface. Vacuum or negative pressure forms the basis for application of force to the crop; it causes the separation of the crop (seed cotton) from the plant and provides the active force for approximation of the bolls to the collection surface. The negative or vacuum side of this equation will of necessity be somewhat more constrained in its geometry than that of the positive side. Provision is made to transport the collected crop (seed cotton) through a set of primary and secondary ducts or tubes to the accumulator/condenser. This system will require specific sizing to facilitate transport and will require geometry that promotes free flow of air and material with minimal resistance and incidence of clogging.

Additional Embodiment 11

A Variable Geometry of the Passageway through which the Plant (Cotton Plant) will pass in the Collection Process.

Geometric variation of the collection passageway can provide an opportunity to manipulate the plant to advantage seeking to expose all aspects of the plant to the collection surface as the plant travels through the machine. Provision is made for the cross sectional geometry of the collection passageway to vary as the plant progresses in a linear fashion through the collection chamber. This geometric variation divides and re-divides the plant, exposing new surface to the collection process. Additionally by “shuffling” the plant as it progresses through the collection chamber opportunities for crop not collected initially to re-orientate and be detected and collected again occur. This geometric variation may also accommodate variations in plant structure found in a single field i.e. part of the passageway may be designed for plants with a single primary stalk and other portions might have geometries that are optimal for plants with a more bush like structure with multiple equivalent stalks.

Additional Embodiment 12

The Employment of Mechanical devices Facilitating Orientation and Approximation of the Crop (Seed Cotton) within the Passageway Through which the Plant (Cotton Plant) will Pass in the Collection Process.

There exists the opportunity to provide within the collection chamber/passageway mechanical or active devices serving to enhance orientation and approximation of the crop to the collection surface. Active assistance to orientation and approximation of the crop helps increase collection probability and yields. As the plant passes through the collection chamber intimate contact with the interior surfaces of the collection chamber will occur. Active devices applied to the interior surfaces of the chamber such as rollers or agitating surfaces can serve to orientate and approximate the crop to the collection surface. Spiral surfaced rollers placed along the keel structure may serve to lift the individual bolls and turn their faces towards the collection surface and orifices/channels.

Additional Embodiment 13

Provision for Geometric Variability to Cross Section as the Plant (Cotton Plant) Passes Linearly through the Collection Passageway

Key to approximation of the crop (seed cotton) is the configuration of the collection chamber to optimize opportunity for collection. This includes approximation of the bolls to the collection orifice/channel, opportunities for orientation and re-orientation of the bolls and the provision for “re-shuffling” of the plant in order to present new surfaces for collection.

Conceivably the collection chamber may transition between two or more geometries as the plant moves linearly through the chamber. Integrated with these parameters of variable geometry is provision for modular expansion of the design both vertically and longitudinally. Ideally these parameters would be set to accommodate different crop conditions and could be re-configured to some degree to suit particular crop conditions for different years.

Additional Embodiment 14

Provision for “Re-Orientation” of the Plant (Cotton Plant) as it Passes through the Collection Passageway. (Transitional Geometry through Variable Cross Sections and Active Mechanical Devices)

Provision is made for the plant to be re-orientated as it passes though the collection passageway. This will facilitate complete collection of the crop (seed cotton) by presenting new areas of the plant to the collection surfaces. Provision is made for variation in the cross sectional geometry of the collection chamber as the plant progresses linearly through the collection passageway. The cross sectional geometry will transition two or more times through the entire collection chamber. Collection orifices/channels may occur on any portion of the internal surface of the collection chamber. Placement of collection orifices will be designed to optimize probability of collection.

Additional Embodiment 15

A Variable Scale Adjustment of the Passageway through which the Plant (Cotton Plant) will Pass in the Collection Process.

Adjustment of height and width of the collection chamber/passageway is provided for in the design aside from modular component aspects of design. The modular components that comprise the collection chamber/passageway will be supported on a frame system that will accommodate adjustments to a limited degree in height and width of the collection chamber/passageway. Ideally this system will be able to respond to immediate harvest conditions by sensing pressure applied to individual plants.

Additional Embodiment 16

A Modular Design Structure Allowing Variability to the Number of Collection Orifices/Channels Employed in a Given Configuration.

Provision is made for modular component construction of the collection head. Utilization of modular component construction allows for design adaptability that can accommodate variations in plant size and density. Modules specifically allow configuration for vertical height variation and length of collection passageway variation. Specific configurations are marked to accommodate average crop conditions for specific localities; however addition or subtraction of modules should be easily accomplished to suit crop conditions of a particular growing season. Ultimately tailoring of configuration to meet particular crop conditions should result in the most efficient operation of the machine.

Additional Embodiment 17

A Modular Design Structure Allowing Variable Size and Geometry of the Passageway through which the Plant (Cotton Plant) will Pass in the Collection Process.

Modular structure supports variation of chamber height to accommodate variation in plant height. Large variations in plant height occur both in differences in variety and type of cotton planted and with climatic conditions occurring within different growing seasons. Drought conditions obviously cause major diminution of yield and plant growth. The modular system as proposed will be adaptable to these variations. In years of drought or other climatic changes affecting plant growth and production the user will be able to add or remove modules and accommodate these changes and in so doing conserve energy by matching the machine to crop conditions.

Additional Embodiment 18

Provision for a Front Seal Maintaining Negative/Positive Air Pressure Environment within the Passageway through which the Plant (Cotton Plant) will Pass in the Collection Process.

Provision is made for a front “pseudo-seal” to contain air within the collection chamber, to prevent ingress of debris from the ground, and to prevent expulsion of cotton lint from the chamber. The front seal mechanism is proposed in the drawings shown as a set of four soft rollers that allow plants to pass through into the collection passageway. The net flow of air through the collection chamber should on average be zero, wherein positive pressure air in is equal to negative pressure air out. Immediate variances of pressures both positive and negative are anticipated due to intermittent changes of flow in the collection process. It should be noted that a front seal mechanism is not limited to roller type geometry; particularly passive types of mechanisms is the preferred method of achieving the functions of the seals.

Additional Embodiment 19

Provision for a Rear Seal Maintaining Negative/Positive Air Pressure Environment within the Passageway through which the Plant (Cotton Plant) will Pass in the Collection Process

Provision is made for a rear “pseudo-seal” to contain air within the collection chamber, to prevent ingress of debris from the ground, and to prevent expulsion of cotton lint from the chamber. Similar to the front seal in form and function the rear seal provides for maintenance of a collection chamber environment. Below an alternate seal mechanism is diagramed, a continuous belt is utilized which adopts a folded geometry where contact is made with the plant.

Additional Embodiment 20

Provision for a Bottom Seal Maintaining Negative/Positive Air Pressure Environment within the Passageway through which the Plant (Cotton Plant) will Pass in the Collection Process.

Provision is made for a bottom seal to contain fluctuating air pressures within the collection chamber and to exclude debris from entry to said chamber from the ground. The preferred method of meeting the requirement for a bottom seal system is an active seal system that is synchronized to ground speed. The bottom seal provides stabilization of the plant as it passes through he collection chamber in addition to its function in forming a “pseudo” seal for air flow. Similar to points made previously regarding the front and rear seals, the bottom seal need not be comprised of an active mechanism. Passive seal methods might also be effective in performing the bottom seal function.

Additional Embodiment 21

Provision for a Bottom Seal Excluding Debris from the Negative/Positive Air Pressure Environment within the Passageway through which the Plant (Cotton Plant) will Pass in the Collection Process.

An additional function of the bottom seal is to exclude debris from the collection chamber. Consideration to the function of debris exclusion is made in the design of the bottom seal system.

Additional Embodiment 22

A Positive Pressure Conduit Supplying Positive Pressure Air to the Passageway through which the Plant (Cotton Plant) will Pass in the Collection Process.

Positive pressure air is supplied to the collection chamber/passageway from the compressor by means of enclosed air ducts. Positive air pressure supplied from the series compressor is brought to the collection chamber/passageway by way of a system of ducts. Provision is made to achieve balanced pressure between the various row heads with pressure monitoring devices and a provision for a valve mechanism to control flow.

Additional Embodiment 23

A negative Pressure Conduit or Plurality of Conduits through which the Crop will Pass for Central Processing/Packaging.

The crop (seed cotton) is transported from the collection orifices/channels to the accumulator chamber utilizing a vacuum tube/conduit. Similar to current designs in function, the proposed system uses air flow to move the crop (seed cotton) to the central accumulator chamber. The condenser system within the accumulator chamber allows negative pressure air flow throughout the entire system, which is somewhat different than current systems wherein seed cotton is currently subjected to vacuum as it comes off the doffer plates, then conveyed into a positive pressure blower stream to the collection basket.

Additional Embodiment 24

A Negative Pressure Conduit or Plurality of Conduits which will Produce a Vacuum at the Collection Orifice/Channel thus Supplying Motive Force for Collection of the Crop (Seed Cotton).

The negative pressure supply utilized in transport of the crop (seed cotton) supplies vacuum for the collection orifices/channels. The preferred configuration utilizes the relatively high vacuum portion of the negative pressure air stream to cause separation of the crop form the plant at the collection orifices/channels and to transport the harvested crop (seed cotton) to the accumulator. It should be noted that the relatively low vacuum portion of air stream described in Additional Embodiment 25 might also be utilized for transport of crop (seed cotton).

Additional Embodiment 25

A Negative Pressure Conduit Produces a Vacuum at the Collection Surface, thus Orientating/Approximating the Crop (Seed Cotton) to the Collection Surface.

A negative pressure air stream produces relatively low vacuum at the collection surfaces (to approximate and orientate bolls to the surface). A negative pressure air stream provides the motive force for the collection surface wherein the bolls are approximated and orientated for collection. The vacuum pressure is controlled apart from the high vacuum system used for separation of the crop (seed cotton) and transport to the accumulator.

Additional Embodiment 26

A Negative Pressure Chamber within which the Crop (Seed Cotton) is Separated from the Air Stream.

This system utilizes a negative pressure vacuum to separate the crop (seed cotton) from the plant and deposit said crop (seed cotton) into a central collection or accumulation chamber for packaging. The positive pressure exhaust generated in creating the vacuum is directed back towards the collection passageway, thus in a sense recycling the air in motion. Provision is made herein to remove the crop (seed cotton) from the negative pressure air stream.

This system utilizes a condenser similar to that utilized in commercial cotton gins after the cotton passes through the gin stand. The crop (seed cotton) travels through ducts in an air stream from the collection heads; this air stream is at negative pressure relative to atmospheric pressure. The function of the condenser is to remove the crop (seed cotton) and less obviously dirt and debris from the air stream.

Additional Embodiment 27

Incorporation of a Condenser Device within the Negative Pressure Chamber.

Use of a condenser to remove cotton from air stream as previously described. The incorporation of a condenser in the specific application of harvesting a crop is unique. The condenser devise is essentially a rotating screen that intercepts the crop in transit through an air stream. The cotton ginning industry has utilized condensers from the late 19^{th} century; and as such is a well known method. Herein a condenser is specifically adapted for accumulation of the crop (seed cotton) within a negative pressure chamber. In practice the crop (seed cotton) clings to the rotating screen and as the screen rotates downward the crop (seed cotton) encounters a doffing roller which separates it from the screen. After separation from the screen the crop (seed cotton) collects in a hopper and is then expelled or extruded from the negative pressure chamber between rollers that form a seal and tend to form the seed cotton into a dense mat.

Additional Embodiment 28

Incorporation of a Secondary Condenser or Filter to Extract Debris from the Air Stream.

A secondary condenser device is proposed here to remove fine particle debris from the air stream. Removal from the air stream will ensure less wear on the compressor devices and prevent the re-introduction of this material into the crop (seed cotton). This may be a unique application of a condensing devise relative to cotton handling. The device is intended to remove fine particulate matter from the air stream and extrude it out of the negative pressure chamber for disposal. The method proposed for extrusion is an auger with a mechanical end seal. The material undergoing extrusion forms a relative air seal through compaction within the auger tube.

Additional Embodiment 29

A Method of Extracting the Separated Crop (Seed Cotton) from the Negative Pressure Chamber through an Air Seal.

Once collected or accumulated on the condenser and doffed off into the hopper the crop (seed cotton) is expelled from the negative pressure chamber between two or more rollers. The rollers involved in removing the crop from the negative pressure chamber have two primary functions. Pressure between the rollers maintains a relative air seal to the negative pressure chamber and the rollers facilitate formation of the crop into a dense mat. The mat is then conveyed away for further processing; ideally to a large round baler. An additional function that these high pressure rollers might perform is in the harvesting of wet crop wherein they would function as a set of “wringers” and compress water out of the wet crop (seed cotton).

Additional Embodiment 30

A Method of Extracting the Separated Crop (Seed Cotton) and Processing it in such a Manner that it forms a Mat for Further Processing (Round Baler).

The bottom roller air seal device processes the crop (seed cotton) so that it forms a mat, in this form the mat can be conveyed to a baler device for packaging. The roller device will form a compressive seal to the negative pressure accumulation chamber. Control of pressure affecting compression on the crop (seed cotton) will produce a mat. The extruding rollers will be able to affect a relative air seal for the negative pressure accumulation chamber whether crop is present or not. Additionally control of activation of this system should provide for detection of cotton within the chamber and intermittent activation in order to produce a continuous mat of material.

Additional Embodiment 31

A Method of Extracting the Separated Debris from the Negative Pressure Chamber through an Air Seal.

Debris collected at the inner secondary filter requires removal as it accumulates; provision is made for an auger with air seal to transport this material away from the condenser device. As debris accumulates at the secondary filter it is doffed off and directed towards an auger device which transports this material in an axial manner out the end of the condenser unit. Ideally a passive seal arrangement is created be containing the debris as it traversed the end of the auger. The nature of debris collected at this stage is fine particulate matter and small cotton; conceivably this material could be compressed as it traversed the auger and be used to affect an air seal itself, alternately a one way flap could be provided at the auger outlet that would provide an air seal against ingress of air to the negative pressure chamber.

Additional Embodiment 32

A Method of Expelling the Separated Debris to the Ground.

Upon removal from the condenser and negative pressure accumulator chamber the debris is diverted to the ground. Debris collected off the secondary filter is waste material; as such it is necessary to convey this material to the ground wherein it contributes to mulch for the field. The simplest method would involve directing this material through a hollow tube to the ground. This material may include oils that give it a rather sticky consistency and active means of transport such as an auger system may be a more effective means of assuring it reaches the ground.

Additional Embodiment 33

Provision of a Compressor (Series Variable Pitch/Speed Fans) to Provide Vacuum for the Negative Pressure Collection/Condensation Process.

The mechanics of producing a high air flow vacuum are rather simple and very similar in arrangement to a conventional vacuum cleaner. Ideally this system utilizes these fans or compressors in a series arrangement. The specific advantage to use of fans in a series arrangement is that control of pressure at the negative side and positive side can be adjusted independently. Series fans have long been used in the cotton ginning industry to provide high flow, high velocity air flow for cotton handling. The proposed arrangement is unique from gin usage in as much as controlling pressures at both ends is important. This goal is achieved by introducing inlet and outlet vents between the series elements of the “compressor”. These vents are responsive to pressure sensors mounted at the collection head and designed to adjust air flow to accommodate immediate needs at the collection head. Further, control of output can be achieved through the use of hydrostatic transmissions driving the fans, as well as variable pitch fans. In all likelihood not all of these devices are necessary for adequate function. However, in a prototype having all of these control systems could yield important information for optimizing efficiency.

Additional Embodiment 34

A Method for Control of Negative Pressure within the Negative Pressure Chamber.

Optimal pressure control requires monitoring of pressures at the collection surface and within the high vacuum portions of the collection/transport conduits. Provision is made to place metering devices within these areas to provide information for control of pressures. Differences in harvesting conditions will undoubtedly require variable control of the pressures involved both on the negative side (vacuum) and positive sides supplying the collection chamber/passageway. Optimal control requires provision for introducing additional air volume through the positive side and the provision for venting excess from the negative side as well. Volume of containment on negative and positive sides provides a dampening effect on the system as a whole and consideration should be given to sizing the overall volume to optimize the collection process.

Additional Embodiment 35

Provision of a Compressor in Series with the Negative Pressure Compressor to Provide Positive Pressure Air to the Positive Air Pressure Conduit for Introduction into the Collection Passageway through which the Plant (Cotton Plant) Passes in the Collection Process.

Series configuration of air compression devices optimizes the opportunity for control of pressures with the various conduits/chambers of the device. Variable force application either through hydrostatic drive mechanisms or DC voltage electric motors allows for optimization of total energy requirements and provides maximal variability to the system to meet changing harvest conditions. Series compressors attain higher air speeds. The primary advantage of this application is to provide a capacity to meet variable needs at the collection interface as well as accommodating the process of transport of the crop (seed cotton) to the accumulation/condensing chamber.

Additional Embodiment 36

Provision of a Compressor in Series with the Negative Pressure Compressor to Provide Positive Pressure Air to the Positive Air Pressure Conduit for Use in Blowing Debris from the Plant (Cotton Plant) Prior to Entrance to the Collection Passageway.

Positive pressure may also be required to function as a debris blower at the front of the individual collection heads to clean the plants prior to traversing the collection chamber/passageway. Provision of positive pressure air stream for debris removal at the fronts of the collection/row heads may be supplied by a common compressor shared between this function and that required for supplying positive pressure to the collection chamber/passageway or may in fact require a separate positive pressure compressor.

Additional Embodiment 37

Interposition of Vents to Allow Egress of Air Between the Series Compressors.

Control function of air pressure is accommodated by controlling egress of air between the series compressors. If specific requirements of the device are such that a higher volume of air is required at the negative side than at the positive side, vents between the series compressors allow the escape of air volume and cause balancing of the system. Conceivably, this device (the cotton picker) has variable relative requirements for negative and positive air flows. Interposition of vents between the series compressors allows for air escape, thus allowing lessened flow to the positive side than the negative side. Balancing compressor speeds and air flow control can provide fairly immediate control of air stream volumes and relative pressures.

Additional Embodiment 38

Interposition of Vents to Allow Ingress of Air Between the Series Compressors

Control function of air pressure is accommodated by controlling ingress of air between the series compressors. If specific requirements of the device are such that a higher volume of air is required at the positive side than at the negative side, vents between the series compressors allows intake of air volume and cause balancing of the system. This embodiment has variable relative requirements for negative and positive air flows. Interposition of vents between the series compressors allows for air introduction, thus allowing for increased air flow to the positive side relative to the negative side. Balancing compressor speeds and air flow control provides fairly immediate control of air stream volumes and relative pressures.

Additional Embodiment 39

Utilization of Information Derived from Collection Frequency in Determining Crop Yield.

The collection frequency of specific collection events at individual collection orifices/channels yields information that when summed produces information useful in determining crop yields. Much recent emphasis has been placed upon crop yield statistics within very specific geographic localities. This is being done on a micro scale wherein a producer can have available statistics that demonstrate productivity on small portions of individual fields. The ultimate usefulness of this information is believed to lie in the adjustment on a micro level of fertilizer and herbicide rates of delivery within small areas. For grain growers in particular these methods have been able to produce 10 to 15 percent saving on these applications of chemicals.

Individual collection events occurring at the collection orifices/channels is monitored and summed to produce crop production statistics. This information can be interfaced with GPS location information as already done in grain production and produce crop yield mapping information. Additionally rates of collection events may be utilized to produce feedback information for optimal performance of the harvester. This in conjunction with crop condition variables (moisture, degree of crop maturity, average size if individual bolls, etc) will undoubtedly lead to information that can “fine tune” the harvester for specific harvesting conditions.

Additional Embodiment 40

Crop Drying at Conveyor to Baling Device. Utilizes Air Flow from Radiator Fed through Alternate Muffler Heat Exchanger to Dry Crop as it Passes in Mat Form on Conveyer to Baler.

Current designs for picking devices make no provision for drying of crop (seed cotton). The design allows for utilization of heat energy from the engine(s) to be conserved in drying the crop (seed cotton) as it is conveyed away from the accumulator chamber towards the packaging unit (round baler).

Current ginning methods incorporate dryers in their processing sequences, these are usually gas fired and are operated at considerable expense. Current picking methods do not provide any means of drying in the picking process and in fact water is added to the crop (seed cotton) in the picking process (via moistening pads). This embodiment allows for harvesting of very wet cotton; the heat exchanger allows for drying, however, it is unlikely that enough heat is provided to cause complete drying of a very wet crop. The heat exchanger system takes the fan driven air from the radiator and ducts this flow across a heat exchanger/muffler adding greater heat which is then ducted through the mat of seed cotton as it is conveyed to the packaging unit (round baler).

Additional Embodiment 41

Provision is made for Reversal of Air Flow for Purge Cleaning of High Vacuum Air Ducts.

A need for purging or cleaning the duct system will arise. Provision is made to reverse of air flow through the high vacuum duct system, and thus cause a purge of the system.

Dirt and debris will likely accumulate on the interior surfaces of the collecting duct systems; a means of removing this accumulation from the system is necessary to maintain optimal performance. This is accomplished with the use of a reversal valve that introduces high pressure air through the system with reversed flow direction. Additionally, with control of collection orifice opening, selectivity of back pressure is attained. It is proposed that in a purging cycle that a proscribed sequence of collection orifice opening can be programmed to optimize the cleaning process.

Additional Embodiment 42

Provision is made for Testing Sequences to Monitor Function of Individual Collection Orifices and their Mechanisms by Means of System Pressurization and Monitoring of Pressure Fluctuations as Individual Collection Orifices are made to Cycle.

The pressurization/purge function provides a means of testing and monitoring integrity of individual collection orifices and their mechanisms. With positive pressurization of the system one can activate individual collection orifices and monitor pressure fluctuation in the system; a properly functioning collection orifice yields a characteristic pressure curve. Cycle variations from this curve are utilized to identify collection orifices that are not functioning properly.

It is anticipated that failure of the servo mechanism will cause no opening of the collection orifice and thus no change in system pressure with attempted activation. Further, leaking helical valves should cause an attenuated pressure drop and thus can be identified. As performance of individual collection orifices is degraded secondary to wear, this monitoring system yields information that predicts when maintenance is necessary.

Additional Embodiment 43

Provision is made so Allow Each Row Head Unit to Rotate Upward on a Frame and thus Provide Service Access to the Sides of Adjacent Row Head Units. Side Access to Heads for Pressure Washer Cleaning of Low Vacuum Chambers.

Providing a means whereby adjacent row heads may be moved upwards and out of the way of a row head requiring maintenance facilitates cleaning and maintenance of each row head. Uniquely, the system allows for independent motion relative to the other row heads to accommodate contour changes of the ground. This system, as further elucidated in Additional Embodiment 44, provides for movement horizontally and angularly form its point of fixation to accommodate curves in rows as is commonly found where crops are planted along contours. The specific attachment to the picker chassis allows much greater freedom of motion than present systems that allow rotation in a single plane. Additionally, the purpose of this linkage extends beyond simple access for cleaning and maintenance functions. This system allows full, independent tracking of each row head, to independently accommodate the immediate conditions of each row of crop.

Additional Embodiment 44

Row Sensing Occurs at Individual Row Heads Allowing Three Dimensional Freedom of Motion about a Single Point of Fixation for Each Head.

The logical further extension of current design provides for independent control of orientation of each row head to the crop. The current design utilizes a row sensing unit on the front aspect of a single row head. The function of this system allows more precise alignment of the row heads to the crop. In a sense, this is a sort of auto-pilot system for the cotton picker; it is claimed to reduce operator fatigue and increase yields. The system provides this function, and in addition, is envisioned to provide precise alignment of individual row heads. Sensors are located both fore and aft on each row head that respond to horizontal and vertical alignment input; this system allows the row heads to accommodate curvature of rows, as well as changes in ground contour. Prioritization may be assigned to an individual head to allow guidance of the entire machine, thus performing the “auto-pilot” function of current design as well.

Additional Embodiment 45

For Active Front Seal Systems Provision is made for Synchronization of Front Seal to Ground Speed.

The front seal mechanism has the capacity to be synchronized to ground speed. Both mechanical means and optical means of monitoring the relative speed of the crow head to ground speed are provided for. The front seal mechanism provides in a sense the first opportunity for orientation of the plant as it enters the collection chamber passageway. If an active front seal mechanism is employed it offers the opportunity to change the form of the plant to some degree as it enters the collection chamber passageway. Linear speed slightly faster than ground speed tends to keep the plant upright with limbs in a natural position; speeds slightly slower than ground speed tend to bend limbs backward and bent the plant away from the machine. Scenarios wherein either configuration is preferable can both be conceived.

Additional Embodiment 46

For Active Rear Seal Systems Provision is made for Synchronization of Rear Seal to Ground Speed.

Synchronization of rear seal mechanism to ground speed provides for minimization of damage to the plant. The mechanics of providing a rear seal is similar to that for the front seal mechanism. Synchronization relative to ground speed is important to minimizing damage to the crop, and this is of particular importance in areas where cotton is harvested with multiple passes across the field.

Additional Embodiment 47

A Burr Excluder at the Collection Orifice/Channel.

Provision is made at the collection orifice/channel for a “burr excluder” to prevent the egress of loose burrs into the high vacuum collection system. Current methods of cotton harvesting tend to entrain portions of the cotton burr with the seed cotton, and thus result in a lower grade of product at the gin. The “burr excluder” device will prevent the collection of loose burr portions with the seed cotton. The physical characteristics of the cotton plant are important in determining the efficacy of this system. Cotton burrs are very firmly attached to the plant and, in general, are not be separated by forces that will separate the seed cotton from the burr; however, some burrs will undoubtedly be fractured as the plant traverses the collection chamber passageway. These burrs and portions of burrs impinge upon the “burr excluder” and are prevented from entering the collection air stream.

Additional Embodiment 48

Side Access to Heads for Pressure Washer Cleaning of Low Vacuum Chambers.

Debris and dirt accumulate within the air passages and ducts of the harvester. Easy access to air passageways are accommodated with sealed access panels at the row heads. As previously articulated, the row heads allow side access to each head for cleaning and maintenance functions. The low vacuum areas of each head are accessed through sealed access panels that are easily removed allowing cleaning by water or pressure washer means.

Additional Embodiment 49

A Passive Seal System for Both Front and Back Applications.

A cost effective method of providing front and rear seals is provided with a passive system. The design utilizes a plurality of flexible diaphragms, through which the plants pass into the collection chamber/passageway. The use of a passive seal system exploits the benefits of lower cost of production, as well as simplified construction without moving parts. The collection chamber/passageway requires only a “pseudo-seal” type of function as the net pressure differential within the chamber is approximately equal to zero; it is in function required to provide resistance to air flow.

Additional Embodiment 50

Variable Articulation for the Collection Points.

The standard distance between rows is currently 30 inches. The optimal distance between rows for certain varieties of cotton in certain locations and growing conditions may be more or less.

In the preferred embodiment, the collection points may be variably articulated to space the heads, chambers or collectors to receive rows as spaced, whether more or less than thirty inches. The positive and negative pressure conduits allow for movement of the collection points along, for example, a bar as needed to adapt to the distance between rows.

Air Control

The process of the introduction of air into the collection chamber and removal of said air with vacuum may occur through one of several embodiments.

1. The simplest embodiment provides a continuous supply of pressurized air, and essentially, a continuous equivalent vacuum removal of the same air. In a system of this type there is no intermittent flow involved; there are no valve structures at the collection orifices/channels. The air circulation in this configuration is continuous with the compressor(s) overcoming the friction to flow (both inherent friction within the system, and the resistance to flow caused by cotton as it is collected and enters into the air stream.)

2. A second embodiment provides one or more valve structures at the collection orifices/channels and renders the vacuum component intermittent in nature. This system is believed to be more efficient in use, as the high vacuum air stream is intermittent, and thus reduces the overall energy requirement. This system that is presented in most of the drawings, which contemplate a continuous pressurized supply with selectively activated valves at the collection orifices/channels.

3. A third embodiment entails the use of both intermittent pressurized supply and high vacuum air stream control. Synchronization of the intermittent air streams allows exploitation of incident pressure waves and enhances the potential force that is used for collection. As a pressure wave propagates from its source there exists a relatively higher wave of air density moving towards the collection orifice/channel. By synchronizing the collection event with the arrival at the collection surface of the high pressure wave, the highest potential force for harvesting may be realized.

4. A fourth embodiment provides a pressurized air stream intermittent in nature, with the high vacuum portion operating continuously. This may yield the potential force of a pressure wave for collection, and would not necessarily require the synchronization of two intermittent events.

Plant Orientation/Collection Chamber

Specific geometry of the collection chamber can be optimized to facilitate probability of collection occurring. Collection surfaces are designed to accommodate a form which the plant “wants” to assume. As the collection chamber passes linearly along the row, there will be a tendency for the limbs of the plant to adopt a horizontal configuration with the tips of the limbs extended in the direction of collection chamber travel. Furthermore, channel like spaces oriented in a more or less horizontal arrangement within the collection chamber tend to concentrate the bolls of cotton along predictable linear pathways. This configuration should substantially reduce the number of collection orifices or channels required to achieve effective collection.

Advantages of Various Embodiments of the Present Invention.

1. Fewer Moving Parts.

The pneumatic system of the present invention has a minimum of moving parts and can be constructed as a single, simply replaceable part. All parts are preferred to be identical in form and interchangeable, facilitating the repair process. In most embodiments, the invention has at least 66% fewer moving parts than current spindle picking devices.

2. Independently Functioning Collection Units

The invention utilizes a single axial collection tube with all moving parts actuated through a single independent motive unit (electric servo device or pneumatically actuated annular piston). Failure of any one of these parts does not adversely affect the performance of the remaining units.

3. Potentially Less Damaging to the Crop.

The pneumatic system does not twist the fiber in the harvesting process. This results in less entrained debris and dirt and does not structurally break the fibers. The invention produces seed cotton in a state that approximates the hand picked cotton of 50 to 150 years ago. Most of the added steps in the ginning process and major innovations to the industry of cotton ginning that have occurred over the past 50 years have been in an effort to accommodate the characteristics of machine picked cotton. Multiple stages of the ginning process are now devoted to removal of debris and extraction of tangled fibers.

4. Comparatively Safe to Operate.

The pneumatic system provides a simple non-rotary mechanism at the collecting units. The only moving parts may be rubber rollers and a track system to provide the chamber seals. Clearances are designed to accommodate a complete cotton plant while causing a minimum of damage, and improve operator safety. The collection units themselves provide little hazard with flexible valve material and vacuum pressures.

5. Lighter Weight

The pneumatic system may be largely constructed of plastic, carbon fiber, high strength fabric and similar light weight materials. A certain advantage is afforded by constructing valve components out of extremely light weight high strength materials due to need to achieve very rapid cycle times at the valve mechanism. In this application, low mass is of benefit in overcoming inertia and facilitating rapid acceleration deceleration of the valve parts.

6. Unitary Construction Simplifies Repair and Replacement.

Each collection unit is completely independent failure or breakage of any unit, and repair simply requires replacement of an individual collection unit. Additionally, as each unit is identical, they are interchangeable. For an immediate fix, one may substitute a failed unit in a higher collection volume portion of the head with a unit located at a more peripheral portion of the head. It is anticipated that helical tube valves will require replacement secondary to failure resulting from abrasion as the locks pass through the device. In all probability, this wear will not occur evenly at the collection units with those units experiencing the highest rates of collection requiring replacement first. Failure of the servo or pneumatic piston devices with sealed lubrication devices and dependence upon electronic activation will likely fail on a random basis.

7. Modular Component Construction Allows Flexibility to Specific Crop Conditions and Potentially Capacity Needs.

The invention allows for a modularity of design to suit the needs of particular growing conditions and crop conditions. Modularity will ideally extend in two planes: height variation will be easily attained with modular sections comprised of horizontal rows of picking units. Linear variations allow for specific crop types or “horizontal density” of crop. In crop producing areas where higher yields are anticipated, the collection passageways may be longer, so that the crop encounters more collection units at a given height as the crop travels through the collection passageway.

8. Packaging of Crop and Handling may be Simplified.

The invention may, in one embodiment, utilize a collection or accumulation chamber with a condenser for removal of material from the air stream. Once collected on the condenser surface, the seed cotton will be doffed off the surface and extruded from the chamber through an air seal. This process will yield the seed cotton in the form of a mat that can then be fed to a round baler device similar to a round hay baler. The baler device will have the capacity to produce approximately 3000 lb bales that are plastic wrapped and dropped in the field as produced. This method of handling has several distinct advantages over current handling devices. The picker does not have to travel to the side of the field to unload picked cotton. The cotton is packaged in an easily manageable form, and equipment required for handling is common where round hay bales are made. The round bales may be transported to the gin on ordinary flat bed tractor-trailer beds in lots of 35 to 40k lbs thus increasing the efficiency of transport and effecting savings in manpower and equipment use.

What is claimed is:

1. A pneumatic harvester, comprising:
a. collection chamber;
b. positive air pressure source that communicates with said collection chamber, wherein said positive air pressure source provides air to said collection chamber at a pressure that is in excess of ambient air pressure;
c. vacuum source that communicates with said collection chamber, wherein said vacuum source provides vacuum to said collection chamber at a pressure that is lower than ambient pressure, and removes air from said collection chamber.

2. A pneumatic harvester as described in claim 1, wherein said collection chamber has a front opening, a rear opening, a bottom opening, and an open central section that is between said front opening and said rear opening, and above said bottom opening, wherein a plant having a material to be harvested enters said front opening, passes through said central opening, and exits said rear opening.

3. A pneumatic harvester as described in claim 2, wherein said front opening comprises a front flexible member having a gap therein and said rear opening comprises a rear flexible member having a gap therein.

4. A pneumatic harvester as described in claim 1, wherein said collection chamber comprises at least one collection port having an opening within at least one wall of said collection chamber, wherein said opening of said collection port is of sufficient size to receive therein said material from said plant, and wherein said collection port communicates with said vacuum source.

5. A pneumatic harvester as described in claim 4, wherein said collection chamber comprises a plurality of vacuum orifices that are present in said at least one wall of said collection chamber, wherein said plurality of vacuum orifices communicate with said vacuum source, and wherein said plurality of vacuum orifices are smaller than said opening of said collection port.

6. A pneumatic harvester as described in claim 1, wherein said central portion of said collection chamber has a receiving area that is adjacent to said opening of said collection chamber, wherein said receiving area tapers to a neck that is positioned behind said receiving area and within said central portion of said collection chamber.

7. A pneumatic harvester as described in claim 4, wherein said central portion of said collection chamber has a receiving area that is adjacent to said opening of said collection chamber, wherein said receiving area tapers to a neck that is positioned behind said receiving area and within said central portion of said collection chamber.

8. A pneumatic harvester as described in claim 7, wherein said at least one collection port is located behind said receiving area of said collection chamber.

9. A pneumatic harvester as described in claim 1, wherein an air pressure within said collection chamber is higher than atmospheric pressure.

10. A pneumatic harvester as described in claim 1, wherein an air pressure within said collection chamber is lower than atmospheric pressure.

11. A pneumatic harvester as described in claim 1, wherein an air pressure within said collection chamber is substantially equal to atmospheric pressure.

12. A pneumatic harvester as described in claim 2, wherein said bottom opening comprises a bottom flexible member having a gap therein

13. A method of picking a crop, comprising the steps of:
a. providing positive air pressure within an area that is at least partially closed;
b. providing negative air pressure with said area;
c. introducing a plant having a crop to be harvested thereon into said area;
d. exposing said crop to said positive air pressure and said negative air pressure;
wherein said crop is severed from a remainder of said plant by a flow of air within said area.
